(19) United States
(12) Patent Application Publication
(10) Pub. No.: US 2014/0366365 A1
(43) Pub. Date: Dec. 18, 2014

(54) Process for Producing Surface-Mount Inductor

(71) Applicant: TOKO, INC., Tsurugashima-shi (JP)

(72) Inventors: Kunio SASAMORI, Higashimatsuyama-shi (JP); Masaaki TOTSUKA, Tsurugashima-shi (JP); Chitoshi SAKAI, Kawagoe-shi (JP); Naoto TAKAHASHI, Tsurugashima-shi (JP); Hiroyasu MORl, Kawagoe-shi (JP)

(73) Assignee: TOKO, INC.

(21) Appl. No.: 14/305,237

(22) Filed: Jun. 16, 2014

(30) Foreign Application Priority Data
Jun. 14, 2013 (JP) 2013-125283

(51) Int. Cl. H01F 41/06; H01F 41/02

(52) U.S. Cl. CPC H01F 41/0612; H01F 41/0246
USPC 29/605

(57) ABSTRACT

Process for producing a surface-mount inductor. A forming die assembly comprises a lower die, a first upper die having three peripheral side surfaces and one opening, and a second upper die for closing the first upper die opening, thereby defining a cavity therein. The coil is formed by winding a wire and processing its led-out end such that it contacts with a side surface of the first and second upper dies. The coil is placed in the cavity from the open side of the first upper die such that its led-out end contacts with a side surface of the first and second upper dies. The coil is sealed with a sealant containing a magnetic powder while the first and second upper dies are clamped together, to form the core. An external electrode is formed on the core and the led-out end of the coil is connected to the external electrode.

### TECHNICAL FIELD

The present invention relates to a process for producing a surface-mount inductor comprising: a coil formed by winding a winding wire; and a core containing a magnetic powder and incorporating the coil therein.

### BACKGROUND ART

A conventional surface-mount inductor includes a type which is obtained by: winding a winding wire to form a coil; and subjecting a mixture of a magnetic powder and a binder to powder compacting molding or subjecting a composite material of a magnetic powder and a resin to compression molding, to form a core in such a manner as to incorporate the coil therein. External terminals are formed on the surface of the core, and the coil is connected therebetween.

This conventional surface-mount inductor is formed, as illustrated in FIG. 6, by: disposing a coil 61, formed by winding a winding wire, on an E-shaped tablet 62A formed from a composite material of a magnetic powder and a resin; housing the coil 61 and the E-shaped tablet 62A in a die assembly comprising a lower die 60A and an upper die 60B such that each of led-out ends 61A, 61B of the coil 61 is clamped between the E-shaped tablet 62A and inner walls of the die assembly; disposing a tablet 62B formed from a composite material of a magnetic powder and a resin on the tablet 62A; and thermally compressing them with the die assembly and a punch 60C (see, for example, JP 2010-245473A).

This conventional surface-mount inductor may also be formed, as illustrated in FIG. 7, by: housing a coil 71, formed by winding a winding wire, in a die assembly comprising a lower die 70A and an upper die 70B such that the coil 71 is clamped between tablets 72A and 72B formed from a composite material of a magnetic powder and a resin; holding led-out ends 71A, 71B of the coil 71 with the lower die 70A and the upper die 70B; and thermally compressing them with the die assembly and a punch 70C (see, for example, JP 2009-170488A).

This conventional surface-mount inductor may further be formed, as illustrated in FIG. 8, by: housing a coil 81, formed by winding a winding wire, in a die assembly comprising a lower die 80A and an upper die 80B; holding led-out ends 81A, 81B of the coil 81 with the lower die 80A and the upper die 80B; and filling a mixture of a magnetic powder and a binder in the die assembly and pressurizing them at a high pressure with the die assembly and a punch 80C.

### SUMMARY OF THE INVENTION

### Technical Problem

Along with downsizing of the surface-mount inductor, the E-shaped tablet is required to be downsized. In this case, in the conventional surface-mount inductor formed by using E-shaped tablet, it is difficult to form the E-shaped tablet due to its complicated shape. Even when the E-shaped tablet can be formed, there is a problem that the tablet is likely to be broken when the coil is mounted thereon or is housed in the die assembly because it is impossible to maintain the strength needed for mounting the coil thereon or for handling the tablet when housed in the die assembly. Maintaining the strength of the E-shaped tablet requires an increase in thickness of the tablet with respect to the coil on an outer surface thereof, which causes an increase in size of a surface-mount inductor to be obtained, or restrictions on size of the coil, resulting in failing to obtain sufficient properties. Further, along with downsizing of the surface-mount inductor, it becomes difficult to dispose the led-out ends of the coil in the die assembly so as to be clamped between the E-shaped tablet and an inner wall of the die assembly, so that there is a problem that the led-out ends of the coil is likely to be buried in the core, and the led-out ends of the coil cannot be sufficiently connected to the external terminal, resulting in disconnection from the external terminal.

Furthermore, the conventional surface-mount inductor formed by holding the led-out ends of the coil by the die assembly has a problem that a large burr is generated in the core due to a leakage of materials constituting the core from a portion of the die assembly which holds the led-out ends of the coil. In the event of generation of the large burr in the core, it is difficult to remove the burr because of the small size of the surface-mount inductor.

It is therefore an object of the present invention to provide a method of producing a surface-mount inductor capable of positioning a coil in a predetermined position in a die assembly, thereby to position the coil in a predetermined position of a core and to prevent led-out ends from being buried in the core without using any special components.

### Solution to the Problem

The present invention provides a method for producing a surface-mount inductor comprising: a coil formed by winding a winding wire; and a core containing a magnetic powder and incorporating the coil therein, the method comprising the steps of: providing a forming die assembly which comprises a lower die, a first upper die having four peripheral sides consisting of three closed sides and one open side, and a second upper die for closing the open side of the first upper die, wherein the lower die, the first upper die and the second upper die are configured to be assembled together to define a cavity therein; preparing the coil by winding a winding wire and fabricating a led-out end of the winding wire into a shape capable of coming in contact with one of the closed sides of the first upper die and the second upper die; placing the coil in the cavity of the forming die assembly from the open side of the first upper die in such a manner as to allow the led-out end of the coil to come in contact with one of the closed sides of the first upper die and the second upper die, and sealing the coil with a sealant containing a magnetic powder in a state in which the first and second upper dies are clamped together, to thereby form the core; and forming an external electrode on the core and connecting the led-out end of the coil to the external electrode.

The present invention also provides a method for producing a surface-mount inductor comprising: a coil formed by winding a winding wire; and a core containing a magnetic powder and incorporating the coil therein, the method comprising the steps of: providing a forming die assembly which comprises a lower die, a first middle die having four peripheral sides consisting of three closed sides and one open side, a second middle die for closing the open side of the first middle die, and an upper die, wherein the lower die, the first middle die, the second middle die and the upper die are configured to be assembled together to define a cavity therein; preparing the coil by winding a winding wire and fabricating a led-out end of the winding wire into a shape capable of coming in contact with one of the closed sides of the first middle die and the second middle die; placing the coil in the cavity of the forming die assembly from the open side of the first middle die in such a manner as to allow the led-out end of the coil to come in contact with one of the closed sides of the first middle die and the second middle die, and sealing the coil with a sealant containing a magnetic powder in a state in which the first and second middle dies are clamped together, to thereby form the core; and forming an external electrode on the core and connecting the led-out end of the coil to the external electrode.

### Effect of the Invention

According to the present invention, there is provided a process for producing a surface-mount inductor comprising a coil formed by winding a winding wire; and a core containing a magnetic powder and the coil incorporated therein, the process comprising the steps of providing a forming die assembly which comprises a lower die, a first upper die having three peripheral side surfaces and one opening, and a second upper die for closing the opening of the first upper die, wherein the lower die, the first upper die and the second upper die are configured to define a cavity therein; preparing the coil by winding a winding wire and processing a led-out end of the winding wire such that the led-out end of the coil contacts with a side surface of the first upper die and the second upper die; placing the coil in the cavity of the forming die assembly from the opening of the first upper die such that the led-out end of the coil contacts with a side surface of the first upper die and the second upper die, and sealing the coil with a sealant containing a magnetic powder while the first and second upper dies are clamped together, to form the core; and forming an external electrode on the core and connecting the led-out end of the coil to the external electrode. This makes it possible to position the coil at a predetermined position of the core so as to prevent the led-out ends from being buried in the core without using any special components, to thereby ensure the coil to be connected to the external electrodes.

According to the present invention, there is also provided a process for producing a surface-mount inductor comprising a coil formed by winding a winding wire; and a core containing a magnetic powder and the coil incorporated therein, the process comprising the steps of: providing a forming die assembly which comprises a lower die, a first middle die having three peripheral side surfaces and one opening, a second middle die for closing the opening of the first upper die, and an upper die. wherein the lower die, the first middle die, the second middle die and the upper die are configured to define a cavity therein; preparing the coil by winding a winding wire and processing a led-out end of the winding wire such that the led-out end of the coil contacts with a side surface of the first middle die and the second middle die; placing the coil in the cavity of the forming die assembly from the opening of the first middle die such that the led-out end of the coil contacts with a side surface of the first middle die and the second middle die, and sealing the coil with a sealant containing a magnetic powder while the first and second middle dies are clamped together, to form the core; and forming an external electrode on the core and connecting the led-out end of the coil to the external electrode. This makes it possible to position the coil at a predetermined position of the core so as to prevent the led-out ends from being buried in the core without using any special components, to thereby ensure the coil to be connected to the external electrodes.

### BRIEF DESCRIPTION OF THE DRAWINGS

FIG. 1 is a transparent perspective view of a surface-mount inductor according to the present invention.

FIG. 2 is a perspective view of the surface-mount inductor according to the present invention.

FIG. 3 is an illustration for explaining a production method of the surface-mount inductor according to the present invention, where FIG. 3(A) is a top view, and FIG. 3(B) is a cross-sectional view along A-B in FIG. 3(A).

FIG. 4 is an illustration for explaining a production method of the surface-mount inductor according to the present invention, where FIG. 4(A) is a top view, and FIG. 4(B) is a cross-sectional view along A-B in FIG. 4(A).

FIG. 5 is a cross-sectional view for explaining another production method of the surface-mount inductor according to the present invention. p FIG. 6 is a partial cross-sectional view illustrating a production method of a conventional surface-mount inductor.

FIG. 7 is a partial cross-sectional view illustrating another production method of a conventional surface-mount inductor.

FIG. 8 is a partial cross-sectional view illustrating yet another production method of a conventional surface-mount inductor.

### DESCRIPTION OF EMBODIMENTS

In a production method of the surface-mount inductor according to the present invention, a surface-mount inductor comprising: a coil formed by winding a winding wire; and a core containing a magnetic powder and incorporating the coil therein is formed by using a forming die assembly which comprises a lower die, a first upper die having four peripheral sides consisting of three closed sides and one open side, and a second upper die for closing the open side of the first upper die, wherein the lower die, the first upper die and the second upper die are configured to be assembled together to define a cavity therein. The coil is formed by winding a winding wire and fabricating a led-out end of the winding wire into a shape capable of coming in contact with one of the closed sides of the first upper die and the second upper die. The coil is placed in the cavity of the forming die assembly from the open side of the first upper die in such a manner as to allow the led-out end of the coil to come in contact with one of the closed sides of the first upper die and the second upper die, and sealing the coil with a sealant containing a magnetic powder in a state in which the first and second upper dies are clamped together, to thereby form the core. An external electrode is formed on the core and the led-out end of the coil is connected to the external electrode.

In the production method of the surface-mount inductor according to the present invention, at the time of clamping the first and second upper dies together, the led-out end of the coil is allowed to be close contact to the closed sides of the first upper die and the second upper die. Thus, even in the case of forming the coil using a low tension winding wire, it becomes possible to ensure the led-out end of the coil to be exposed on an end surface of the core.

Further, in a production method of the surface-mount inductor according to the present invention, a surface-mount inductor comprising: a coil formed by winding a winding wire; and a core containing a magnetic powder and incorporating the coil therein is formed using a forming die assembly which comprises a lower die, a first middle die having four peripheral sides consisting of three closed sides and one open side, a second middle die for closing the open side of the first middle die, and an upper die, wherein the lower die, the first middle die, the second middle die and the upper die are configured to be assembled together to define a cavity therein. The coil is formed by winding a winding wire and fabricating a led-out end of the winding wire into a shape capable of coming in contact with one of the closed sides of the first middle die and the second middle die. The coil is placed in the cavity of the forming die assembly from the open side of the first middle die in such a manner as to allow the led-out end of the coil to come in contact with one of the closed sides of the first middle die and the second middle die, and sealing the coil with a sealant containing a magnetic powder in a state in which the first and second middle dies are clamped together, to thereby form the core. An external electrode is formed on the core and the led-out end of the coil is connected to the external electrode.

In the production method of the surface-mount inductor according to the present invention, at the time of clamping the first and second middle dies together, the led-out end of the coil is allowed to be close contact to the closed sides of the first middle die and the second middle die. Thus, even in the case of forming the coil using a low tension winding wire, it becomes possible to ensure the led-out end of the coil to be exposed on an end surface of the core.

### Embodiment

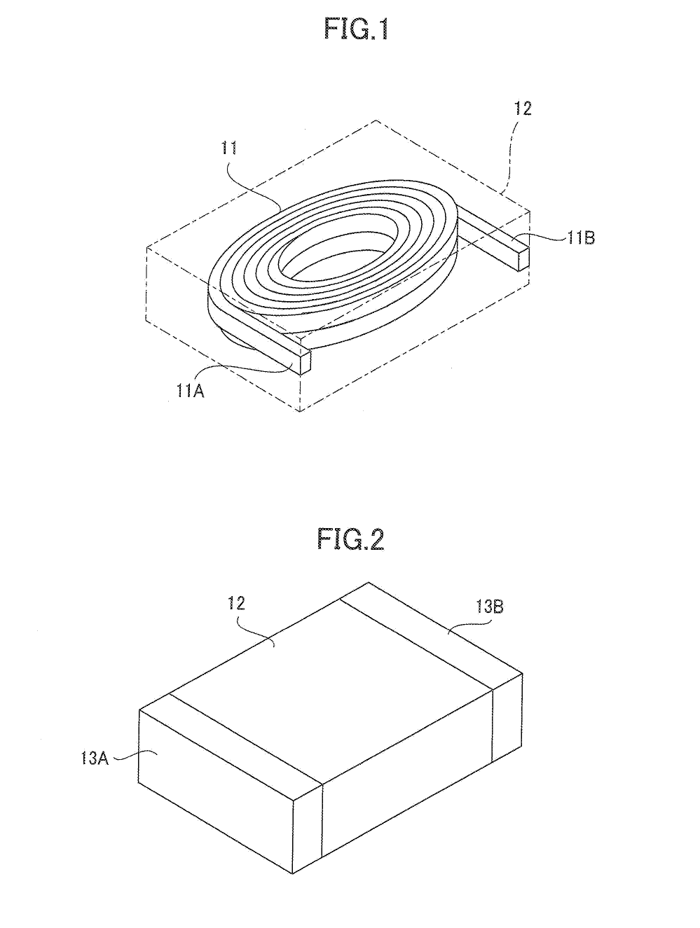

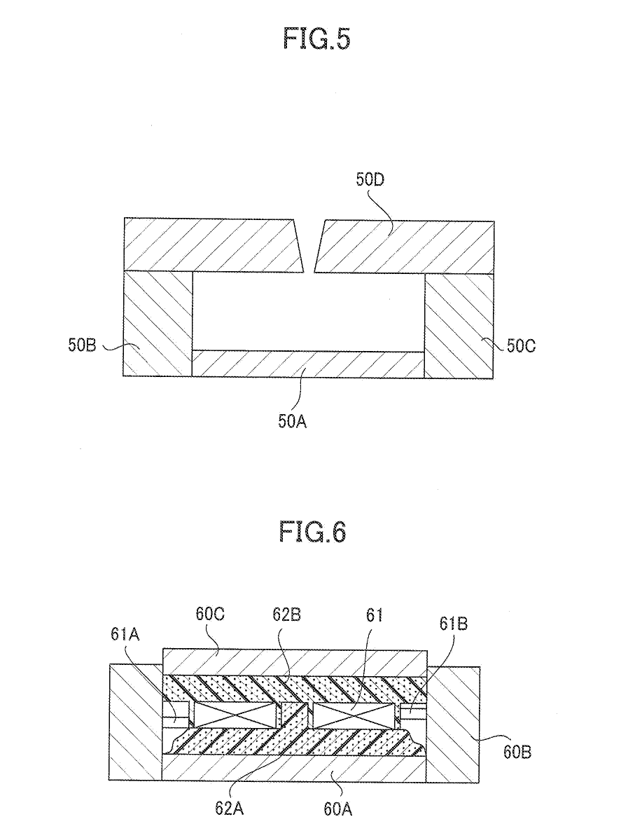

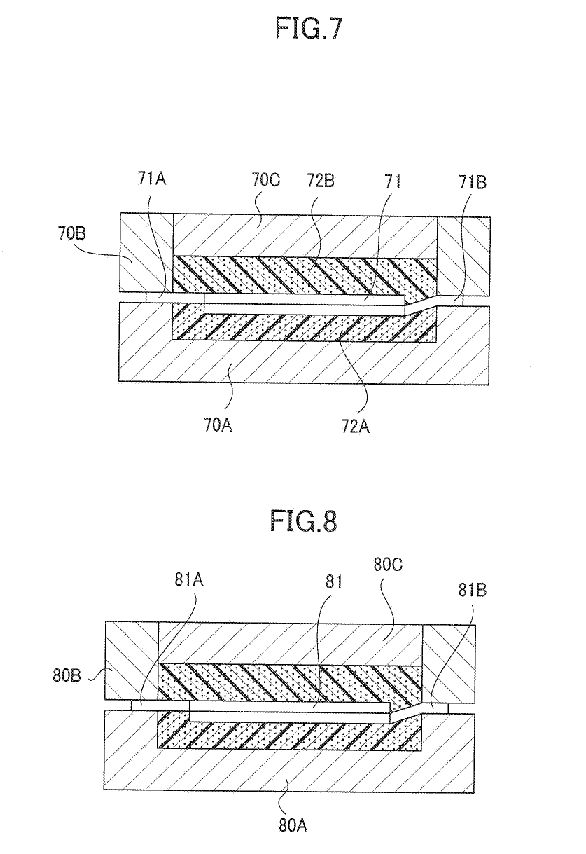

Embodiment of the production method of the surface-mount inductor according to the present invention will now be described with reference to FIGS. 1 to 5.

FIG. 1 is a transparent perspective view of a surface-mount inductor according to the present invention.

In FIG. 1, the reference numerals 11 and 12 designate a coil and a core, respectively.

The coil 11 is formed by winding a rectangular wire in two tiers to allow its opposite ends to be positioned on an outer periphery of the coil. The coil 11 has led-out ends 11A and 11B formed by leading out each opposite end of the rectangular wire from the outer periphery of the coil.

The core 12 incorporates the coil 11 using a composite material of a magnetic powder and a resin, and is formed to allow the led-out ends 11A and 11B of the coil 11 to be exposed on the end surface. For the magnetic powder, a metal magnetic powder is used. For the resin, an epoxy resin is used. External electrodes 13A and 13B are formed on the surface of the core 12, as illustrated in FIG. 2.

Then, the coil 11 is connected between the external electrodes 13A and 13B by each of the led-out ends 11A and 11B of the coil 11 being connected to respective one of the external electrodes 13A and 13B.

This surface-mount inductor is produced in the following manner. Firstly, a coil is formed by winding a rectangular wire in two tiers to allow its opposite ends to be positioned on an outer periphery of the coil.

Then, ends of the rectangular wire positioned on an outer periphery of the coil are fabricated to allow each of them to come in contact with an aftermentioned closed sides of a first upper die and a second upper die of an forming die assembly, to thereby form led-out ends.

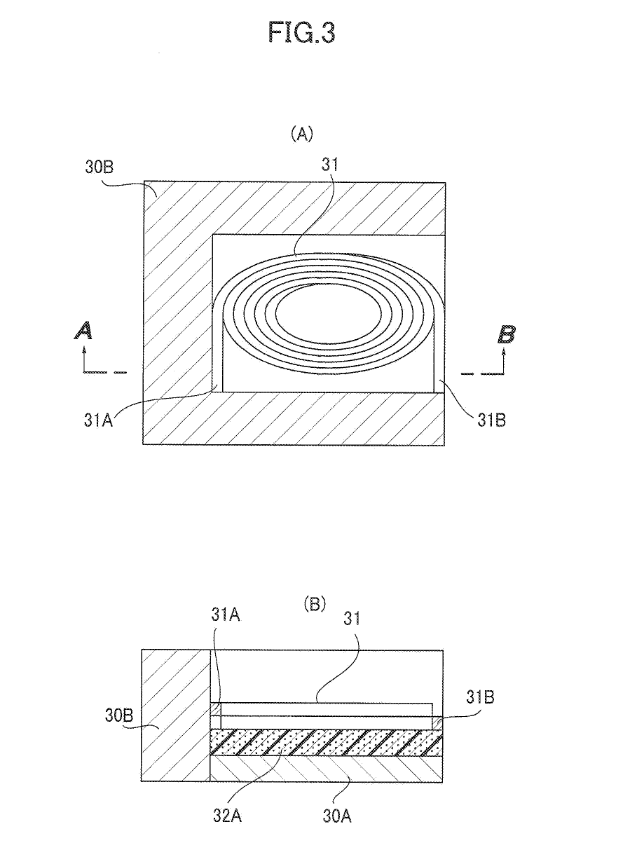

Next, as illustrated in FIG. 3, the coil 31 is housed in a cavity of the forming die assembly from an open side of the first upper die 30B to allow a surface of the led-out end 31A of the coil 31 to come in contact with one of the closed sides of the first upper die 30B and a surface of the led-out end 31B of the coil 31 to come in contact with the second upper die. At this time, a tablet 32A made by pre-forming a composite material of an iron-based metal magnetic powder and an epoxy resin into a plate is housed on a lower die 30A, on which the coil 31 is housed.

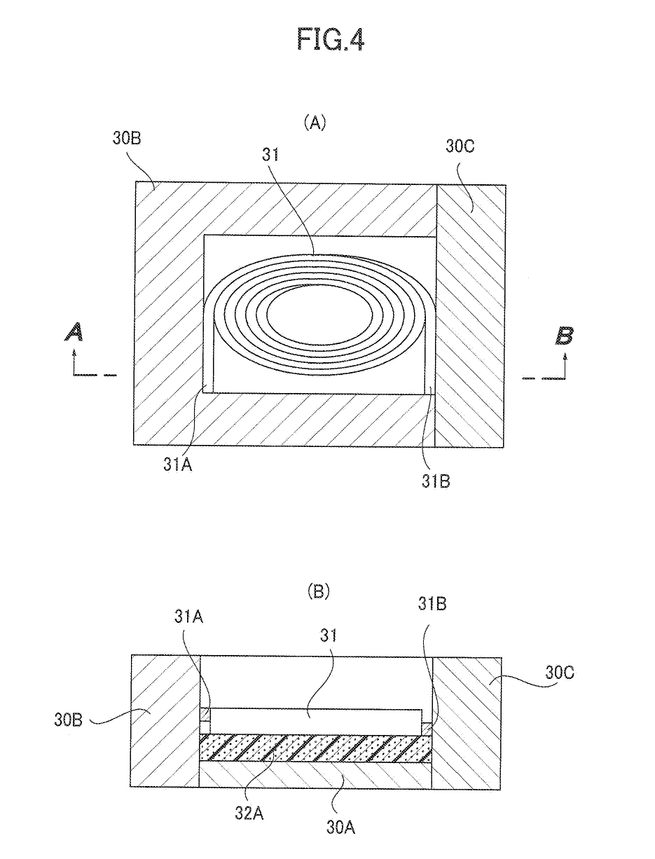

Further, as illustrated in FIG. 4, the second upper die 30C is placed to close the open side of the first upper die 30B of the forming die assembly having the tablet 32A and the coil 31 housed therein, and the first upper die 30B and the second upper die 30C are clamped together. This makes it possible to allow each of the led-out ends 31A and 31B of the coil 31 to be close contact to respective one of the closed sides of the first upper die and the second upper die.

Subsequently, the composite material of an iron-based metal magnetic powder and an epoxy resin is filled in the cavity of the forming die assembly having the coil 31 housed therein, or the tablet made by pre-forming the composite material of an iron-based metal magnetic powder and an epoxy resin into a plate is housed in the cavity of the forming die assembly having the coil 31 housed therein.

Further, these are subjected to a compression molding performed by the lower die 30A, the first upper die 30B, the second upper die 30C and a punch at a temperature ranging from 120 to 250° C. In this way, the coil is sealed with a sealant containing a magnetic powder, thereby to form a core 12 incorporating the coil and allowing the led-out ends of the coil to be exposed on the end surface thereof.

Then, an electrically-conductive paste is applied on the core 12 and cured to form external electrodes 13A, 13B on the core 12. The external electrodes 13A, 13B may be plated with a material formed by appropriately selecting one or more from materials such as Ni, Sn, Cu, Au and Pd.

While an embodiment of a production method of a surface-mount inductor according to the present invention has been described above, the invention is not limited to this embodiment. For example, the forming die assembly used in the above embodiment may be a type which comprises a lower die 50A, a first middle die 50B having four peripheral sides consisting of three closed sides and one open side, a second middle die 50C for closing the open side of the first middle die, and an upper die having a pin gate provided therein, wherein the lower die, the first middle die, the second middle die and the upper die are configured to be assembled together to define a cavity therein. In this case, a coil is formed by winding a winding wire and fabricating led-out end of the winding wire into a shape capable of coming in contact with one of the closed sides of the first middle die and the second middle die. This coil is placed in the cavity of the forming die assembly from the open side of the first middle die in such a manner as to allow the led-out end of the coil to come in contact with one of the closed sides of the first middle die and the second middle die, and is sealed with a sealant containing a magnetic powder by injecting the sealant from the pin gate in a state in which the first and second middle dies are clamped together, to thereby form the core. An external electrode is formed on the core and the led-out end of the coil is connected to the external electrode.

Further, the metal magnetic powder for use in the core may have a wide variety of compositions, and may be a metal magnetic powder having a surface coated with an insulator such as a glass, or a metal magnetic powder having an oxidized surface. Further, the resin for use in the core may be other thermosetting resin such as a polyimide resin or a phenol resin, or may be a thermoplastic resin such as a polyethylene resin or a polyamide resin. Furthermore, the core may be formed by filling a mixture of a magnetic powder and a binder in a cavity of the forming die assembly having the coil housed therein, and subjecting them to pressure molding performed with the die assembly and a punch at a high pressure. In this case, the magnetic powder for use in the core may be a metal magnetic powder, a metal magnetic powder having a surface coated with insulators such as a glass, or a metal magnetic powder having an oxidized surface.

### EXPLANATION OF CODES

11: coil
12: core

1. A process for producing a surface-mount inductor comprising a coil formed by winding a winding wire; and a core containing a magnetic powder and the coil incorporated therein, the process comprising the steps of
providing a forming die assembly which comprises a lower die, a first upper die having three peripheral side surfaces and one opening, and a second upper die for closing the opening of the first upper die, wherein the lower die, the first upper die and the second upper die are configured to define a cavity therein;
preparing the coil by winding a winding wire and processing a led-out end of the winding wire such that the led-out end of the coil contacts with a side surface of the first upper die and the second upper die;
placing the coil in the cavity of the forming die assembly from the opening of the first upper die such that the led-out end of the coil contacts with a side surface of the first upper die and the second upper die, and sealing the coil with a sealant containing a magnetic powder while the first and second upper dies are clamped together, to form the core; and
forming an external electrode on the core and connecting the led-out end of the coil to the external electrode.

2. A process for producing a surface-mount inductor comprising a coil formed by winding a winding wire; and a core containing a magnetic powder and the coil incorporated therein, the process comprising the steps of
providing a forming die assembly which comprises a lower die, a first middle die having three peripheral side surfaces and one opening, a second middle die for closing the opening of the first middle die, and an upper die, wherein the lower die, the first middle die, the second middle die and the upper die are configured to define a cavity therein;
preparing the coil by winding a winding wire and processing a led-out end of the winding wire such that the led-out end of the coil contacts with a side surface of the first middle die and the second middle die;
placing the coil in the cavity of the forming die assembly from the opening of the first middle die such that the led-out end of the coil contacts with a side surface of the first middle die and the second middle die, and sealing the coil with a sealant containing a magnetic powder while the first and second middle dies are clamped together, to form the core; and
forming an external electrode on the core and connecting the led-out end of the coil to the external electrode
